(19) United States
(12) Patent Application Publication
(10) Pub. No.: US 2020/0045037 A1
(43) Pub. Date: Feb. 6, 2020

(54) TOKEN STORE SERVICE FOR PLATFORM AUTHENTICATION

(71) Applicant: salesforce.com, Inc., San Francisco, CA (US)

(72) Inventors: Freeman Parks, San Francisco, CA (US); Tanda Hamonangan, San Francisco, CA (US); Rahul Singh, San Francisco, CA (US); John Rice, San Francisco, CA (US)

(21) Appl. No.: 16/050,528

(22) Filed: Jul. 31, 2018

(51) Int. Cl. H04L 29/06; H04L 29/08; H04L 12/66

(52) U.S. Cl. CPC H04L 63/0807; H04L 63/18; H04L 12/28; H04L 67/32; H04L 12/66; H04L 63/102

(57) ABSTRACT

A digital data platform, e.g., suitable to support e-commerce, can utilize a digital data processing device—separate and apart from those used in client app authentication and request routing—for executing a token validation service to both generate and validate tokens. This frees the network gateway to route incoming requests for authorization separately from those from already-authorized apps. This is more cost-effective than adding gateways to provide such processing. By separating the token-generating logic from the gateways, this also allows tokens to be stored in and replicated among remote data centers.

### BACKGROUND

The invention pertains to routing traffic on the Internet. It has particular application in routing received by enterprise servers from client applications.

E-commerce transactions have traditionally been conducted via end user access to vendor websites. Advances in front-end and back-end server technologies have improved the user experience through better website interactivity, search and payment options, among others. And, while the ubiquity of standardized web browsers has facilitated development of satisfactory user interfaces at low cost, special-purpose client applications vastly improve the user experience and, ultimately, increase vendor revenue recognition.

E-commerce platform providers have accommodated the increased demand for e-commerce client applications (“apps”) through applications program interfaces (APIs) that permit remote client apps to access the same wealth of server resources as server-based user front-ends. Industry adoption of authorization protocols, such as OAuth and OAuth 2.0, insures that those applications access only user data only if and when permitted by the user herself.

Proliferation of client apps and server software to support them has proven problematic for platform providers, who rely of network gateways not only to route authorization requests but, also, to validate tokens received from authorized apps—an approach that has not proven scalable.

### BRIEF DESCRIPTION OF THE DRAWINGS

A more complete understanding of the discussion that follows may be attained by reference to the drawings, in which:

FIG. 1 depicts a digital data platform of the type providing an example embodiment.

### DETAILED DESCRIPTION OF THE ILLUSTRATED EMBODIMENT

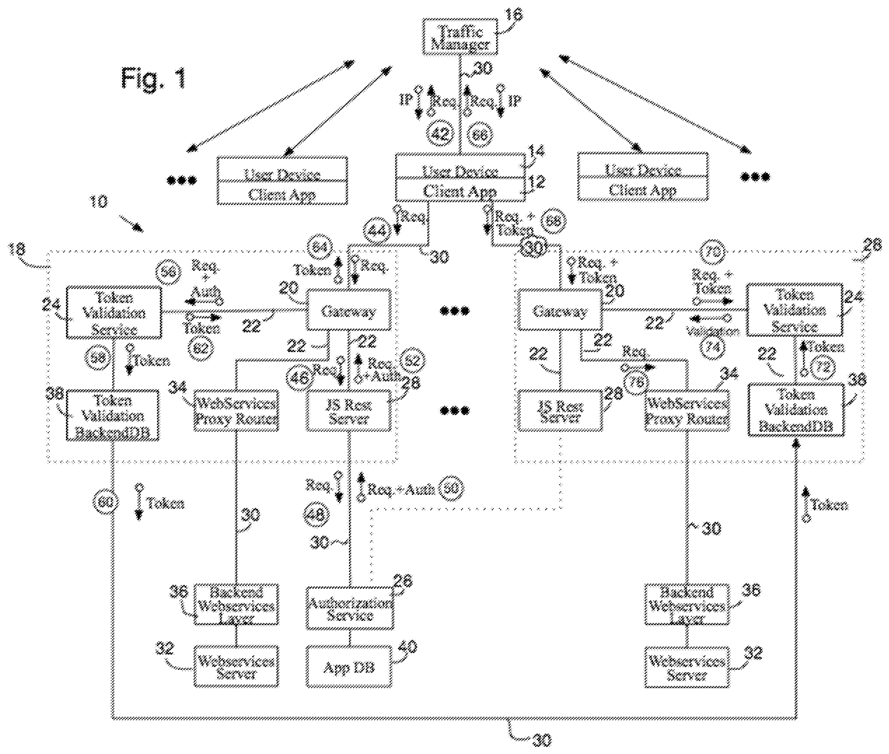

FIG. 1 depicts an example embodiment comprising a digital data processing platform 10 that serves as a security front-end for authenticating a client application (“app”) 12 executing on user digital data processor (“user device”) 14 and validating requests from that app 12 for access to user data, e.g., stored on a remote server 32. In the illustrated embodiment, platform 10 forms part of an e-commerce system that permits app 12 to access that user data as part of a commercial or other business-related transaction, though, other embodiments may have alternative purposes.

User device 14 is a mobile phone, personal digital assistant, laptop computer, desktop computer, minicomputer or other digital data device of the type commercially available in the marketplace capable of executing client apps such as client app 12.

Client app 12 comprises conventional software of the type known in the art that accesses user data on a remote server, e.g., server 32, via requests over a wide area network (WAN), metropolitan area network (MAN), the Internet and/or other networks of the type known in the art (collectively, “internet 30”). That data, which can be secured by password protection, encryption and/or other techniques known in the art, can include, by way of non-limiting example, e-commerce store accounts, credit card information, and so forth. As per convention in the art, before attempting to access such secured data, the client app is configured to (i) request authentication, e.g., via generating and transmitting an appropriate request over the internet, and (ii) include with the subsequent datan access requests a “bearer” or other token received in response to the authentication request, if granted.

Though a single app 12 and user device 14 are discussed below, it will be appreciated that platform 10 can serve as a security front-end supporting the authentication and validation of multiple such apps and devices for accessing multiple servers of secured user data, represented herein by illustrative server 32.

The platform 10 includes plurality of functionally independent subsystems, 18, 28, each capable of directly or indirectly (i.e., via remote servers) serving as an aforesaid security front-end for one or more servers, e.g., server 32, that maintain secured user data, authenticating client apps, e.g., app 12, and validating subsequent requests by them for access to those servers. Although two subsystems 18, 28 are shown in the drawing, other embodiments may fewer of them, i.e., only a single such subsystem, or a greater number of them. In the illustrated embodiment, the multiple subsystems 18, 28 are architected and operated similarly to one another, though other embodiments may differ in this regard.

The illustrated embodiment includes a traffic manager 16. This can be part of platform 10 (and, more particularly, for example, of one or more of its subsystems 18, 28) or can, as shown in the drawing, be a stand-alone device on internet 30. The traffic manager, which can be coupled for communications with client app 12 and user device 14 by way of internet 30, is a network device of the type commercially available in the marketplace for traffic shaping, here, from client apps (e.g., 12) to subsystems 18, 28 in embodiments that have multiple ones of them. Such traffic-shaping can be for purposes of load-balancing or otherwise, e.g., to route requests to subsystems 18, 28 based on user device type, app type, secured data server location or otherwise—all as per convention in the art as adapted in accord with the teachings hereof.

Illustrated traffic manager 16 provides traffic shaping by responding to requests from the client app 12 by returning the IP address of the gateway 20 of a selected subsystem to which the request is to be directed. The manager 16 can make that selection on a round-robin basis (e.g., by cycling through available subsystems 18, 28) or other basis as per convention in the art as adapted in accord with the teachings hereof. In some embodiments, the traffic manager 16 returns an IP address to the requesting client app 12 for retransmission of that request with that IP address, while in other embodiments the traffic manager 16 forwards the request to the gateway 20 of the selected subsystem. Although a single such traffic manager 16 is shown in the drawing, embodiments may provide for multiple such devices.

Illustrated subsystem 18 comprises a network gateway (“gateway”) 20 of the type commercially available in the marketplace as adapted in accord with the teachings hereof. Here, gateway 20 serves as an interface between internet 30 and a data center or other network node comprising subsystem 18. Gateway 20 is coupled for communications with client app 12 and/or traffic manager 16 via internet 30, and to an associated second digital device providing a token validation service via network 22, which comprises CAT 5e, fiber optic, or other structured cabling of the type supporting data communications within the aforesaid data center or other network node. Gateway 20 is also coupled, directly or indirectly, via network 22 and, optionally, one or more other devices and networks (e.g., internet 30), to (i) a third digital data processor providing an authorization service 26, and (ii) server 32, providing “substantive processing” of validated requests received from client app 12. As used here, substantive processing means accessing (e.g., for purposes of creating, reading, updating, or deleting) data secured by that server 32 on behalf of a user, e.g., of device 14.

The second digital data device is a conventional digital data processor of the type available in the marketplace suitable for use as a network device, e.g., in a data center. It is configured by execution of software or otherwise to provide a token validation service 24, i.e., to (i) issue access or “bearer” tokens of the type known in the art (e.g., in accord with the OAuth protocol, the OAuth 2.0 protocol, a JSON Web Token, or otherwise) to a requesting client app, e.g., app 12, and (ii) validate such tokens upon subsequent presentation with a datan access request from the client app 12, e.g., to insure that those tokens have not expired or are not otherwise inconsistent with the request—all in the conventional manner known in the art, albeit, executing within a separate digital data processor than that used as gateway 20 and/or for client app authorization (e.g., as discussed below in connection with third digital data processor and authorization service 26).

Illustrated token validation service 24 maintains a database 38 of tokens issued by it. This can include, for each token, token value, expiration time, associated client app, associated server and/or other parameters commonly stored in connection with token issuance and validation (e.g., per the OAuth protocol or other applicable standards) in the art. In the illustrated embodiment, that database 38 is dedicated to subsystem 18 (and can, furthermore, be disposed within the data center or other network node in which that subsystem resides) or can be used commonly by multiple such subsystems, e.g., 18, 28, whether disposed locally to one of them or otherwise.

The third digital data processor is, likewise, a conventional digital data processor of the type available in the marketplace suitable for use as a network device, e.g., in a data center. It is configured by execution of software or otherwise to at least initiate authorization of the client app, e.g., by passing a request for such authorization to a remote authorization service 26. In this regard, illustrated subsystem 18 includes an associated JavaScript REST (REpresentational State Transfer) server 28 that is coupled to gateway 20 via local network 22 and that supports communications coupling between the gateway 20 and authorization service 26 via internet 30. That service can provide authorization in accord with the OAuth protocol, the OAuth 2.0 protocol, JSON Web Token, or otherwise. Authorization service 26 can be dedicated to subsystem 18 (and can, furthermore, be disposed within the data center or other network node in which that subsystem resides) or can be used commonly by multiple such subsystems, e.g., 18, 28, as in the case of the illustrated embodiment. In some embodiments, the authorization service 26 is provided within the subsystem 18 itself, executing on a server provided within the data center or other network node in which that subsystem resides.

Illustrated authorization service 26 maintains a database 40 of client apps, e.g., app 12, users and user devices for which authorization is permitted, challenge parameters for such authorizations and/or other information used or generated in connection therewith, all per convention in the art as adapted in accord with the teachings hereof. In the illustrated embodiment, that database 38 is dedicated to service 26, though in other embodiments it may be shared by multiple such services, all per convention in the art.

Illustrated web services server 32, which substantively processes requests from client app 12 that have been include a validated by token validation service 14, can comprise a further digital data processor, separate and apart from gateway 20, the second digital data processor providing token validation service 24 and the third digital data processor providing authorization service 26—though, in some embodiments, it is co-housed with and executes on the third digital data processor along with authorization service 26. The server 32 can be dedicated to subsystem 18, as illustrated here, or can be used commonly by multiple such subsystems, e.g., 18, 28. Illustrated subsystem 18 includes an associated web services proxy router 34 that routes or otherwise intermediates requests between gateway 20 and a backend 36 of the web server 32 and, whence, to sever 32 itself.

The various severs and other digital data devices of the illustrated embodiment may be of the same type, though, more typically, they constitute a mix of devices of differing types. And, although two web services servers 32 (of subsystems 18, 28, respectively) are depicted and described here, it will be appreciated that other embodiments may utilize a greater number of these devices, homogeneous, heterogeneous or otherwise, networked or otherwise, to perform the functions ascribed hereto. It will further be appreciated that one or more of those servers 32, as well as the respective authentication services ascribed to the subsystems 18, 28, may be implemented in a multi-tenant database system or other system or environment.

As those skilled in the art will appreciate the “software” referred to herein comprises computer programs (i.e., sets of computer instructions) stored on transitory and non-transitory machine-readable media of the type known in the art as adapted in accord with the teachings hereof, which computer programs cause the respective devices to perform the respective operations and functions attributed thereto herein. Such machine-readable media can include, by way of non-limiting example, hard drives, solid state drives, and so forth, coupled to the respective digital data devices 12, 14 in the conventional manner known in the art as adapted in accord with the teachings hereof.

With continued reference to FIG. 1, in operation, platform 10 routes requests from client app 12 to an e-commerce site, such as that or those operating on or in connection with servers 32, as described below.

At the outset, client app 12 seeks authorization to access secured data for a user of device 14. To that end, in step 42, which is optional in embodiments having only a single subsystem 18, the app 12 transmits a request to traffic manager 16 for the IP address of a gateway of the subsystem to use in obtaining such authorization. The request can be transmitted in HTTP or other protocol per convention in the art, as can the response from traffic manager 16—in this case, the IP address, say, of subsystem 18.

In step 44, the client app 12 transmits an authorization request to the gateway 20 at the IP address received in step 42. Upon receiving that request, gateway 20 of subsystem 18 determines whether the request contains a token indicating that it is from an already-authenticated and validated app 12. If it does not, the gateway 20 of subsystem 18 routes the request to the authorization service 26. See, step 46. In the illustrated embodiment, that request is routed to the service 26 via JS ReST server 28 of subsystem 18, as shown in the drawing (see step 48); although, other embodiments may vary in this regard.

The authorization service 26 validates the request (and, more generally, the app 12) to determine if it is made on behalf of the user on behalf of which the data is secured—in the case, for example, the user of device 14. This is done in the conventional manner known in the art, e.g., in accord with the OAuth protocol, the OAuth 2.0 protocol or otherwise, as adapted in accord with the teachings hereof. This can include, for example, querying the user of app 12 and device 14 via a web page, via a challenge code, in both instances with or without two-factor authentication, or otherwise per convention in the art. Information driving the authorization process can be obtained by the authorization service 26, e.g., from database 40, again, per convention in the art.

If authorization is obtained, the service 26 returns the request and authorization code to the gateway 20 of subsystem 18. See step 50. In the illustrated embodiment, that routing is via server 28 of subsystem 18. See step 52. These steps 50, 52 can be performed in a conventional manner known in the art in view of the teachings hereof.

In step 54, the gateway 20 of subsystem 18 routes the authorization code and request to the token validation service 24 of that subsystem, again, in a conventional manner of the art as adapted view of the teachings hereof. Upon receipt of the authorization code, the token validation service of subsystem 18 generates a token for the app 12 in a conventional manner of the art as adapted in accord with the teachings hereof. See step 56.

In step 58, the service 24 of subsystem 18 stores the token to the token database 38 of subsystem 18 per convention in the art as adapted in accord with the teachings hereof. The service 24 of subsystem 18 distributes that token to the token databases of the other subsystems making up platform 10—here, the token database 38 of subsystem 28. See step 60. Such token distribution can be carried out in a conventional manner of the art as adapted in accord with the teachings hereof, and it may be conduction by other functionality operating in accord with platform 10 (e.g., by another of the servers or other digital data processors on that platform).

In step 62, the service 24 of subsystem 18 returns the token to gateway 20 of subsystem 18 which, in turn, returns it to app 12 for use in validating subsequent requests made by it. See step 64. These steps can be performed in a conventional manner of the art as adapted in accord with the teachings hereof.

Once the token is received by the client app 12, it appends that token to requests for datan access subsequently generated by the app 12 so that platform 10 can validate those requests before forwarding them to the server 32. This is illustrated in the discussion below by operation of subsystem 28, which uses the token distributed to it in step 60 in order to perform such validation.

In step 66, which is optional in embodiments having only a single subsystem, the app 12 transmits a request to traffic manager 16 for the IP address of the gateway of the subsystem to use in seeking secured data. As above, the request can be transmitted in HTTP or other protocol per convention in the art, as is the response from traffic manager 16—in this case, the IP address, say, of subsystem 28.

In step 68, the client app 12 transmits a datan access request to the gateway 20 of subsystem 28 at the IP address received in step 66. The app 12 appends the token received in step 64 to the request. Step 68 is performed in a conventional manner of the art as adapted in accord with the teachings hereof.

Upon receiving that request, gateway 20 of subsystem 28 determines whether it contains a token indicating that it is from an already-authenticated and validated app 12. If it does, the gateway 20 of subsystem 28 routes the request and token to the token validation service 24 of subsystem 28. See step 70, which is performed in a conventional manner of the art as adapted in accord with the teachings hereof.

Upon receiving the request and token, that token validation service confirms that the token is unexpired and that it is valid vis-à-vis the request to which it is appended. This can be performed in a conventional manner of the art as adapted in accord with the teachings hereof. Thus, for example, although the token was not originally generated by the service 24 of subsystem 28, that service is able to perform validation by using the token distributed to it from the service that did generate the token (i.e., the token validation service 24 of subsystem 18). This is indicated in the drawing by step 72.

If the token validation service 24 of subsystem 28 is able to validate the token, it returns an indication of such to the gateway 20 of that subsystem. See step 74. This can be done in a conventional manner of the art as adapted in accord with the teachings hereof.

Upon receiving that indication, the gateway 20 of subsystem 28 forwards the datan access request to the associated web services server 32, here, by way of router 34 and backend 36. See step 76. This can be done in a conventional manner of the art as adapted in accord with the teachings hereof. Upon receiving the request, the server 32 substantively processes it and gives app 12 access to the secured user data.

Described above are digital data processing platforms comprising one or more subsystems capable of at least initiating authorization of the client application, issuing tokens to that application and validating subsequent requests from the application including that token. It will be appreciated that the embodiments described here and shown in the drawings are merely examples, and that other embodiments fall within the scope of the claims that follow.

By way of non-limiting example, although platform 10 is described above as being for e-commerce, it is suitable for other applications in which client apps require authorization, token issuance and validation, whether for access to secured data or otherwise.

In view of the foregoing, what is claimed is:

1. A method of routing requests to a digital data platform, comprising
receiving, at a network gateway digital data device that is coupled to the internet, a request to the platform from a client application that is coupled to the network gateway via an internet,
with the network gateway digital data device, determining if the request includes an access token and, if so, routing at least that access token to a token validation service executing on a second digital data device that is in communications coupling with the network gateway digital data device,
with the token validation service, determining whether the token received from the network gateway digital data device is valid and, if so, returning an indication thereof to the network gateway digital data device that routed the request,
with the network gateway digital data device, responding to an indication from the token validation service that the token is valid by routing the request to a server that processes the request to access data secured on behalf of a user, and
with the network gateway digital data device, routing the request to an authorization service if the request does not include an access token, the authorization service executing on a third digital data device that is in communications coupling with the network gateway digital data device.

2. The method of claim 1 comprising, with the request authorization service, determining whether the client application is authorized by the user on behalf of which the data is secured and, if so, returning an authorization code to the network gateway digital data device.

3. The method of claim 2 comprising, with the network gateway digital data device, routing the request and authorization code to the token validation service.

4. The method of claim 3 comprising, with the token validation service, responding to the request and authorization code received from the network gate digital data device by returning an access token to the network gateway digital data device.

5. The method of claim 4 comprising, with the network gateway digital data device, returning the access token to the client application.

6. The method of claim 5 comprising, with the token validation service,
storing the access token to a token database associated with the second digital data processor, and
forwarding the access token over one or more networks to one or more other token databases associated with one or more other digital data processors on which one or more other token validation services execute.

7. A digital data platform comprising a plurality of subsystems, each having
a network gateway digital data device that is coupled to an internet and that is associated a respective IP address,
a second digital data device configured to provide a token validation service, the second digital data device being coupled to the network digital data device by structured cabling,
a third digital data device configured to at least initiate an authorization service, the third digital data device being coupled to the network digital data device by structured cabling,
the network gateway digital data device responding to a request received from a client application on the internet by determining if the request includes an access token and, if so, routing at least that access token to the second digital data device,
the token validation service of the second digital data device determining whether the token received from the network gateway digital data device is valid and, if so, returning an indication thereof to the network gateway digital data device that routed the request,
the network gateway digital data device responding to an indication from the token validation service that the token is valid by routing the request to a server that processes the request to access data secured on behalf of a user.

8. The platform of claim 7, the request authorization service responding to a request routed from the network gateway digital data device by determining whether the client application authorized by the user on behalf of which the data is secured and, if so, returning an authorization code to the network gateway digital data device.

9. The platform of claim 8, the network gateway digital data device routing the request and authorization code received from the request authorization service to the token validation service.

10. The platform of claim 9, the token validation service responding to the request and authorization code received from the network gateway digital data device by returning an access token to the network gateway digital data device.

11. The platform of claim 10, the network gateway digital data device, returning the access token to the client application.

12. The platform of claim 10, the token validation service forwarding the access token to at least one other said subsystem for use by the token validation services executing therein to validate an access token received from the network gateway digital data device of that other subsystem.

13. The platform of claim 7 comprising a traffic manager that generates an IP address of a selected subsystem in response to a request by client application.

14. A front-end platform for routing requests to a digital data platform, comprising
a network gateway digital data device that is coupled to the internet to receive a request to the platform from a client application that is coupled to the network gateway via the internet,
the network gateway digital data device determining if the request includes an access token and, if so, routing at least that access token to a second digital data device executing a token validation service and, if not, routing the request to a third digital data device executing an authorization service,
the token validation service determining whether the token received from the network gateway digital data device is valid and, if so, returning an indication thereof to the network gateway digital data device,
the network gateway digital data device, responding an indication from the token validation service that the token is valid by routing the request to a server that processes the request to access data secured on behalf of a user.

15. The platform of claim 14, the request authorization service determining whether the request is authorized by the user on behalf of which the data is secured and, if so, returning an authorization code to the network gateway digital data device.

16. The platform of claim 15, the network gateway digital data device routing the request and authorization code to the token validation service.

17. The platform of claim 16, the token validation service responding to the request and authorization code received from the network gate digital data device by returning an access token to the network gateway digital data device.

18. The platform of claim 17, the network gateway digital data device returning the access token to the client application.
